(19) United States
(12) Patent Application Publication
(10) Pub. No.: US 2025/0229325 A1
(43) Pub. Date: Jul. 17, 2025

(54) CONFIGURABLE END-EFFECTOR USED WITH A CASTING PROCESS

(71) Applicant: Alotech Limited R&D, LLC, Brooklyn, OH (US)

(72) Inventors: John Grassi, Brooklyn, OH (US); Brian Wright, Cicero, NY (US); Matthew Burdick, Hartland, WI (US); Eric Ehrhardt, Brookefiled, WI (US); Gary Kuehnel, New Berlin, WI (US)

(73) Assignee: Alotech Limited R&D, LLC, Brooklyn, OH (US)

(21) Appl. No.: 19/025,362

(22) Filed: Jan. 16, 2025

Related U.S. Application Data
(60) Provisional application No. 63/733,766, filed on Dec. 13, 2024.
(60) Provisional application No. 63/621,514, filed on Jan. 16, 2024.
(60) Provisional application No. 63/623,684, filed on Jan. 22, 2024.
(60) Provisional application No. 63/733,931, filed on Dec. 13, 2024.

(51) Int. Cl. B22D 27/04; B22D 30/00; B25J 11/00; B25J 15/00

(52) U.S. Cl. CPC B22D 27/04; B22D 30/00; B25J 11/005; B25J 15/0019

(57) ABSTRACT

A configurable end-effector is provided for a robotic system used in a casting process. The end-effector can have one or more ablate and/or cooling modules that can apply an ablating material and/or cooling fluid to a mold for the solidification or the solid to solid transformation of the metal component of the part to be cast or formed in the mold or tooling. The end-effector may incorporate one or more air push or vacuum modules that can be used to remove or move the ablate material phase state change and/or the cooling fluid after the ablate material and/or cooling fluid absorbs heat from the part. The end-effector can include one or more energy modules that can be used to introduce heat to the mold and/or tooling and the formed component part so that additional processes can be performed on the component part. The end-effector may have one or more sensing modules that can determine the temperature and location of the part and then provide that information to a controller to control the operation of the various energy modulus that control energy extraction or cooling and input energy to offset any energy loss to the system prior, during, or thereafter a state change occurs of the component material within the ablate mold and tooling both in liquid and solid conditions or with various solid fraction of the cast material.

### CROSS-REFERENCE TO RELATED APPLICATIONS

This application claims the benefit of U.S. Provisional Patent Application No. 63/733,766, filed Dec. 13, 2024, and entitled “Configurable End-Effector Used with a Casting Process,” which application is hereby incorporated by reference herein in its entirety. This application claims the benefit of U.S. Provisional Patent Application No. 63/621,514, filed Jan. 16, 2024, and entitled “Casting Support,” which application is incorporated by reference herein in its entirety. This application claims the benefit of U.S. Provisional Patent Application No. 63/623,684, filed Jan. 22, 2024, and entitled “Systems and Methods for Wheel Manufacture,” which application is incorporated by reference herein in its entirety. This application claims the benefit of U.S. Provisional Patent Application No. 63/733,931, filed Dec. 13, 2024, and entitled “Multi Indirect Injection Solidification Technology,” which application is incorporated by reference herein in its entirety.

### BACKGROUND

The present application generally relates to an end-effector used with a casting process. More specifically, the present application is directed to a configurable end-effector having different modules that provide different functionalities, such as cooling, heating, or thermal imaging of the part (including combinations thereof), during the casting process.

In traditional casting processes, a molten alloy metal is poured into a mold and solidifies, or freezes, through a loss of latent heat of solidification to the mold. A more recent casting process that addresses many of the problems encountered in the traditional approach utilizes an ablation solidification process that is generally described in U.S. Pat. No. 7,216,691, the disclosure of which is incorporated herein by reference in its entirety.

“Ablation” refers to the removal of an aggregate mold by an erosion process in which the application of an ablating medium (e.g., a fluid) causes the aggregate to disintegrate to grain size and the grains to be flushed away in the flow of the fluid. In this way, the surface of the solidifying alloy metal component can be revealed, allowing direct contact between the ablate or ablating medium and the alloy metal of the solidifying casting. The direct contact of the ablating medium and the conversion of state by the ablating material maximizes heat flow from the alloy metal, greatly increasing the rate of removal of the latent heat of solidification and cooling of the alloy metal. The timing of the application of the ablating medium can be prior to the solid fraction content of the alloy metal being completed; the freezing of the alloy metal in the mold can maximize solidification of the alloy reactions to enhance certain microstructure characteristics of the alloy metal, which provide enhanced mechanical properties of the solidified alloy metal. In addition, the timing of the application of the ablating medium can be delayed to minimize particular properties of the alloy metal. One example of ablation includes the use of an aggregate mold bonded with a soluble binder and the use of a solute, such as one containing water, as the ablating medium, which can be endothermic to thereby enable cooling by the ablating medium.

One way to apply the solute (or the ablating medium) to the aggregate mold is to incorporate a fluid nozzle into the end-effector of a robotic arm such that the end-effector (and the corresponding spray from the fluid nozzle) can be moved to a desired location relative to the mold. However, if, prior to or during the ablation process, other types of steps are to be incorporated into the casting process to enhance the properties of the alloy metal being solidified to produce a part or component, the part (and any remaining portion of the mold) have to be moved in order for the other steps to be completed. Thus, it may be desirable to incorporate different functionality into the end-effector such that additional steps (or processes) can be performed on the part or component during the ablation process without having to move the core package or mold containing the cast part or component.

### SUMMARY

The present application generally pertains to a configurable end-effector for a system used in a casting or solidification process. The end-effector can have one or more ablate and/or cooling modules that can apply an ablating medium such as an ablate material, substance or media, which can be generally referred to as a cooling fluid, to a mold for the solidification of the part or component to be cast in the mold. The mold can be chosen from any of many different types of devices that are able to contain and shape the liquid alloy metal into the desired shape. The end-effector may incorporate one or more vacuum and/or airflow modules that can be used to remove the ablate (or ablating) material and/or cooling fluid by either a suction or pulling force (e.g., a vacuum) or a pushing force (e.g., an airflow). The vacuum or airflow module can remove the ablate material or cooling fluid from the vicinity of the part after the ablate material or cooling fluid undergoes a state change or change in physical state (e.g., liquid to gas), or after any remaining cooling fluid, which has not changed state, has absorbed latent heat from the alloy metal undergoing solidification to create the part or component. Thereafter, the ablate media or cooling fluid can also remove heat from the component after solidification has ended. The end-effector can include one or more energy modules that can be used to introduce heat to the mold and/or the part or component being cast so that additional processes can be performed on the part. The end-effector may have one or more sensing modules that can determine the temperature of the part and then provide that information to a controller to control the operation of the other modules of the end-effector (e.g., ablate and/or cooling modules and/or energy modules) and/or the operation of the system (e.g., movement of the end-effector by the system). The sensing modules can also incorporate measurement system modules that can work individually or interactively to collect dimensional information about the part through the liquid to solid transitions and the contraction of the alloy. In addition, the end-effector can also incorporate one or more supply modules that can be used to supply molten alloy metal to the mold and/or one or more cutting modules that can be used to remove the ingates from the part during solidification of the part.

The present application also pertains to the use of the end-effector with a mold construction to enable the production of alloy parts (including metal alloys) that have significantly improved properties. In this regard, the alloy parts formed using the disclosed end-effector and mold construction have significantly faster cooling times, resulting in significantly faster production times. The formed alloy parts can exhibit a smaller grain size and eutectic boundary finer microstructure, more homogenous microstructure, and less porosity, resulting in improved ductility and tensile strength. The physical characteristics of such cast alloy parts can be comparable to those of forged alloy parts but are associated with significantly lower production costs. In addition, the disclosed systems and techniques of forming alloy components address the problem of using conventional aggregate molds for casting metal parts by preventing the “pull in” of aggregate materials into the surface of the metal part during the solidification cooling process, disrupting a smooth finish. The disclosed systems and techniques can also provide for a unique finish surface that is distinguishable from conventional casting processes.

An advantage of the present application is the ability to introduce heat to the part or component to be cast during the solidification process, including while the part and/or mold are moving, not moving, or a combination of moving and not moving.

Another advantage of the present application is providing a surface finish on the cast part that can improve the coefficient of friction of the part surface without further post-processing of the cast part.

Still another advantage of the present application is the ability to form complex shaped alloy parts (e.g., parts with long thin sections) while preventing issues associated with premature solidification of the molten alloy during the casting process.

Other features and advantages of the present application will be apparent from the following more detailed description of the identified embodiments, taken in conjunction with the accompanying drawings which show, by way of example, the principles of the application.

### BRIEF DESCRIPTION OF THE DRAWINGS

FIG. 1 shows a schematic perspective view of an embodiment of a system for use in a casting process.

FIG. 2 is a block diagram of an embodiment of an end-effector.

FIG. 3 is a block diagram of an embodiment of the end-effector from FIG. 2 showing placement of modules.

FIG. 4 is a block diagram of another embodiment of the end-effector from FIG. 2 showing placement of modules.

FIG. 5 shows a perspective view of an embodiment of an ablate and/or cooling head for an ablate and/or cooling module.

FIG. 6 shows an exploded view of an embodiment of a spray nozzle for an ablate and/or cooling module.

FIG. 7 shows a cross-sectional view of an assembled nozzle end of the spray nozzle of FIG. 6.

FIG. 8 shows a cross-sectional view of an assembled connector end of the spray nozzle of FIG. 6.

FIG. 9 shows a schematic perspective view of another embodiment of a system for use in a casting process.

FIG. 10 shows a partial schematic top view of the system of FIG. 9.

FIG. 11 shows a partial cross-section of an embodiment of the mold from FIGS. 9 and 10.

FIG. 12 shows a schematic top view of an embodiment of a system for use in a casting process.

FIG. 13 shows a schematic perspective view of an embodiment of a system for use in a casting process.

FIG. 14 shows a schematic perspective view of still another embodiment of a system for use in a casting process.

FIG. 15 shows a block diagram of an embodiment of a controller for the casting system.

FIG. 16 shows a flow diagram of an embodiment of a solidification process using the system of the present application.

FIGS. 17A and 17B show perspective views of different embodiments of the mold from FIG. 1.

FIG. 18 shows an enlarged top view of the insert from FIG. 17A.

FIG. 19 shows a cross-sectional view of the insert from FIG. 18.

FIG. 20 shows an embodiment of a cooling graph with temperature changes over time for five different areas during a solidification process.

Wherever possible, the same reference numbers are used throughout the drawings to refer to the same or like parts.

### DETAILED DESCRIPTION

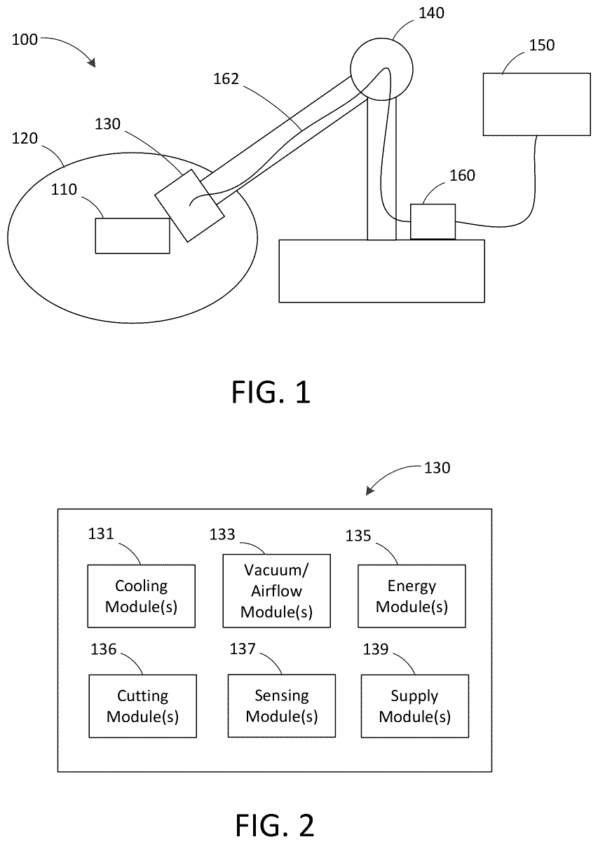

FIG. 1 shows an embodiment of an embodiment of a system 100 that can be used during a solidification thermal management casting process. A mold (or tool) 110, which may be filled with a molten alloy metal, can be positioned on a base or table 120 such that an end-effector 130 connected to a robotic arm 140 can access the entire mold 110, which may include exterior and/or interior surfaces of the mold 110. As used herein a “mold” includes any construction or apparatus for forming a cast alloy part. As used herein, a mold specifically can include an all metal tool construction, a mold constructed of aggregate, and combinations thereof. The movement of the robotic arm 140 and the operation and control of the end-effector 130 can be controlled by a controller 150. In some embodiments, depending on the size of the mold 110 and the desired actions to be performed during the solidification thermal management casting process, more than one robotic arm 140 and end-effector 130 may be needed to access the entire mold 110 and/or perform or complete all desired actions. In one embodiment, the robotic arm 140 can be a Fanuc LR Mate 200iD/7L, but in other embodiments, any suitable robotic arm can be used.

The mold 110 can be made or partially made of mineral or ceramic aggregate(s) bonded with a binder or bonding material. In other embodiments, the binder or bonding material may not be used with the aggregate material (i.e., the mold 110, or portion thereof, is formed from only aggregate material). More than one kind of aggregate can be employed in some embodiments. In addition, more than one kind of binder, if used, can be employed in different embodiments. The aggregate and binder, if used, can be mixed and used to make a mold 110 or a portion of the mold. The mixture can be cured in contact with the tooling (or pattern) so that the shape of the mold 110 or corresponding portion of the mold is as accurate as possible. The parts of the mold 110 are then assembled to make a complete mold 110. Once the mold 110 is formed, the mold 110 may be temporarily stored, or immediately filled with a molten alloy metal (or melt). The filling of the mold 110 can be accomplished in a number of ways: 1) the molten alloy metal can be poured into the mold 110 using a technique known as “gravity pouring;” 2) the mold may be filled more gently by gradually changing the angle or slope of the mold 110 using a technique known as “tilt casting;” or the molten alloy metal can be transferred into the mold through a ‘counter gravity’ delivery system such is disclosed in U.S. Pat. Nos. 6,103,182 and 6,841,120 which are incorporated herein by reference in their entireties. After delivering the molten alloy metal into the mold 110, the mold 110 can be positioned on the table 120 for the solidification portion of the casting process. In another embodiment, the mold 110 may be filled with molten alloy metal on the table 120, thereby avoiding the step of moving the filled mold 110 to the table 120.

Once the mold 110 is positioned on the table 120, whether filled with molten alloy metal or unfilled, the end-effector 130 connected to the robotic arm 140 (as controlled by the controller 150) can perform one or more steps of the solidification thermal management casting process on the mold 110. As shown in FIGS. 2-4, the end-effector 130 can include one or more ablate and/or cooling modules 131 (generally referred to as a cooling module) and one or more vacuum/airflow modules 133 that can be used during the solidification of the cast component or part in the mold 110. The vacuum/airflow module 133 can include vacuum functionality (i.e., the ability to remove materials via suction) and/or airflow functionality (i.e., the ability to remove materials via movement of compressed air or other suitable gas). The vacuum/airflow module 133 can include a vacuum portion and/or an airflow portion depending on the location of the vacuum/airflow module 133 in the end-effector 130, the other modules incorporated into the end-effector 130 and the casting process being performed. In other embodiments, the vacuum/airflow module 133 can have equipment that provides either the vacuum functionality or the airflow functionality depending on the configuration of the equipment (e.g., a first configuration for vacuum functionality and a second configuration for airflow functionality).

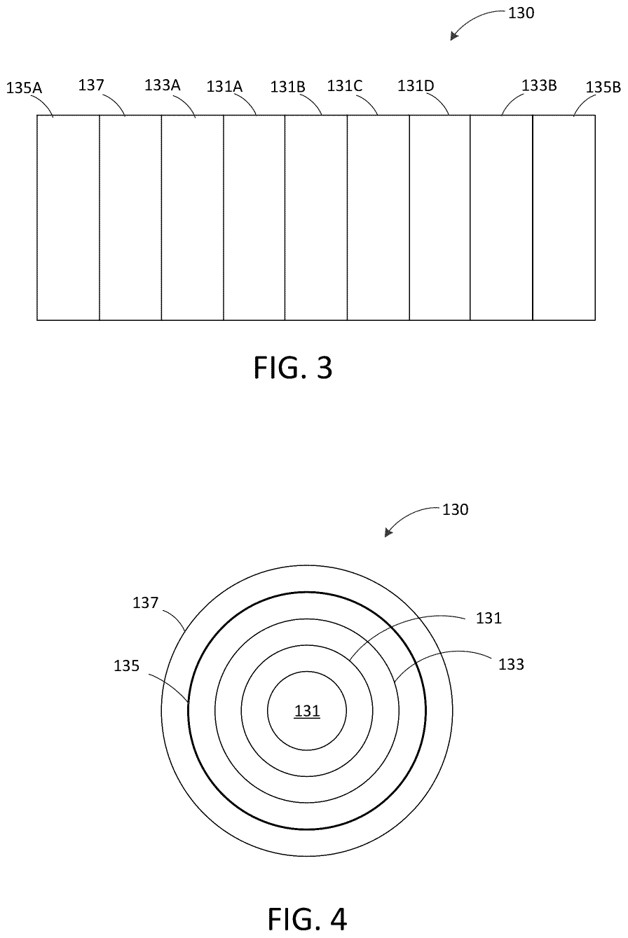

In addition, the end-effector 130 can include one or more energy modules 135 to apply heat to the cast component or part and one or more sensing modules 137 to sense the temperature of the cast component or part. In some embodiments, the end-effector 130 may also include one or more supply modules 139 (see FIG. 2) that can be used to supply molten alloy metals to the mold 110 and/or cutting modules 136 (see FIG. 2) that can provide a high pressure water jet to cut portions (e.g., the ingates) of the cast component or part while the cast component is in a semi-solid state. The end-effector 130 can have any suitable shape and/or arrangement that permits the end-effector 130 to perform any functions and/or steps needed by the casting process to obtain a component or part having preselected characteristics. In the embodiment of FIG. 3, the end-effector 130 can have a block or rectangular shape with the modules placed next to one another. In the embodiment of FIG. 4, the end-effector 130 can have a disc or circular shape with the modules arranged concentrically.

In an embodiment, the modules of the end-effector 130 may be “complete” modules that include all the hardware or equipment required for the module and that have corresponding “supply” connections (e.g., power, control, fluid, etc.) for proper operation of the module. In another embodiment, one or more of the modules on the end-effector 130 may only include a portion of the module (e.g., an end device associated with the module) with the remaining portion of the module (e.g., the corresponding hardware, equipment, etc. for the module) being located elsewhere (e.g., on the robotic arm 140). The removal of a significant portion of a module from the end-effector 130 can reduce the weight at the end-effector and provide more precision when moving the end-effector 130 with the robotic arm 140 by reducing the momentum of the end-effector 130 during movement.

For example, a vacuum/airflow module 133 or a cooling module 131 incorporated in the end-effector 130 may incorporate only an end nozzle (or other orifice) at the end-effector 130. The end nozzle at the end-effector 130 can be connected by appropriate connections (e.g., wiring, tubing, etc.) to the remaining equipment and hardware (e.g., motors, compressors, pumps, controllers, etc.) of the vacuum/airflow module 133 or the cooling module 131, which can be located separate from or apart from the end-effector 130 (e.g., at the base of the robotic arm 140). In another example, the sensing module 137 may include one or more sensors at the end-effector 130 that are connected by a wired connection (e.g., an Ethernet cable or glass transmission fiber) or a wireless connection (e.g., Bluetooth) to an individual main control device located on the robotic arm 140 in near proximity to the end-effector 130.

As shown in FIG. 1, the modules of the end-effector 130 can be connected to one or more module equipment boxes 160 by corresponding module connections 162. The module connections 162 may include corresponding wiring and/or tubing for each of the modules connected to the module equipment box 160. The module equipment box 160 can then be connected to the controller 150 such that the hardware and equipment for each module located in the module equipment box 160 can receive corresponding control instructions and information from the controller 150. The module equipment box 160 can also have connections to receive power, water, air, etc., as required, for the hardware and equipment of each module located in the module equipment box 160. While the embodiment of FIG. 1 shows only 1 module equipment box 160 and module connection 162, it is to be understood that more than 1 module equipment box 160 and more than 1 module connection 162 can be used in other embodiments.

By moving a significant portion of the hardware and equipment for a module to the module equipment box 160, the remaining portion of the module at the end-effector 130 can be of reduced mass so that the rapid motion and movement of the robotic arm 140 has the lowest possible moving mass at the end-effector 130 to thereby limit deceleration and improve positioning control accuracy associated with moving mass translation movement. In addition, the lower moving mass at the end-effector 130 can provide improved acceleration control of the end-effector 130 that can then be used to provide improved control of the latent heat transmittal interval. In an embodiment, the configuration of the end-effector 130 and the robotic arm movement coupled with known time and coordinates can act as a controlled interval cooling system that can be controlled by corresponding algorithms at the controller 150. It is noted that the end-effector 130 when used as a stationary device (i.e., the end-effector 130 does not move) is mostly insufficient to provide the controlled interval cooling system, absent the translation of the end-effector 130, on “thick section” parts but may be sufficient on larger “thin section” parts that are only several millimeters (e.g., 1 mm to 8 mm) in thickness.

In an embodiment, a configuration of the end-effector 130 with only end devices for the modules can be as small as 25 mm in diameter and still include cooling modules 131 (e.g., ablate systems), sensing modules 137 (e.g., vision systems and/or temperature measurement systems), and vacuum/airflow modules 133. The end devices for the modules on the end-effector 130 can be connected by module connections 162 (e.g., tubular and wire structures) to module equipment boxes 160 located at the base of the robotic arm 140 or in the near vicinity of the robotic arm 140. In an embodiment, an end device for a module at the end-effector 130 can be either a “tube” or an “electric” device or a “light transmission” device.

As shown in the embodiment of FIG. 3, the end-effector 130 can incorporate four cooling modules 131A, 131B, 131C, 131D positioned side-by-side. Next to the cooling modules 131A and 131D are the vacuum/airflow modules 133A and 133B. Next to the vacuum/airflow module 133A can be a sensing module 137 and next to the vacuum module 133B can be an energy module 135B. Another energy module 135A can be located next to sensing module 137. It is to be understood that while the end-effector 130 of FIG. 3 shows one arrangement of modules, the end-effector 130 can have any suitable arrangement of modules, which may include more or fewer (or even the omission) of a particular type of module than is shown in FIG. 3. In addition, the placement of the modules in the end-effector 130 may be varied from what is shown in FIG. 3 (e.g., energy module 135B may be replaced with a sensing module 137 or cooling modules 131 may be alternated with vacuum/airflow modules 133).

Each cooling module 131 incorporated into the end-effector 130 can include a spray head and corresponding nozzle or just a nozzle (with the corresponding spray head being located remote from the end-effector 130) to deliver the ablating material and/or cooling fluid to the mold 110 and the cast component or part. In one embodiment, the ablating material and/or cooling fluid can be water (H₂O), air, atomized water (i.e., a mixture of air and water), liquid nitrogen or carbonated water (carbon dioxide (CO₂) and water). However, in other embodiments, any other suitable ablate material or cooling fluid may be used. Further, the selection and number of the cooling module(s) 131 to be included in the end-effector 130 can be based on the part to be cast, the type of mold and a determination of the amount of cooling that is needed for the solidification of the part.

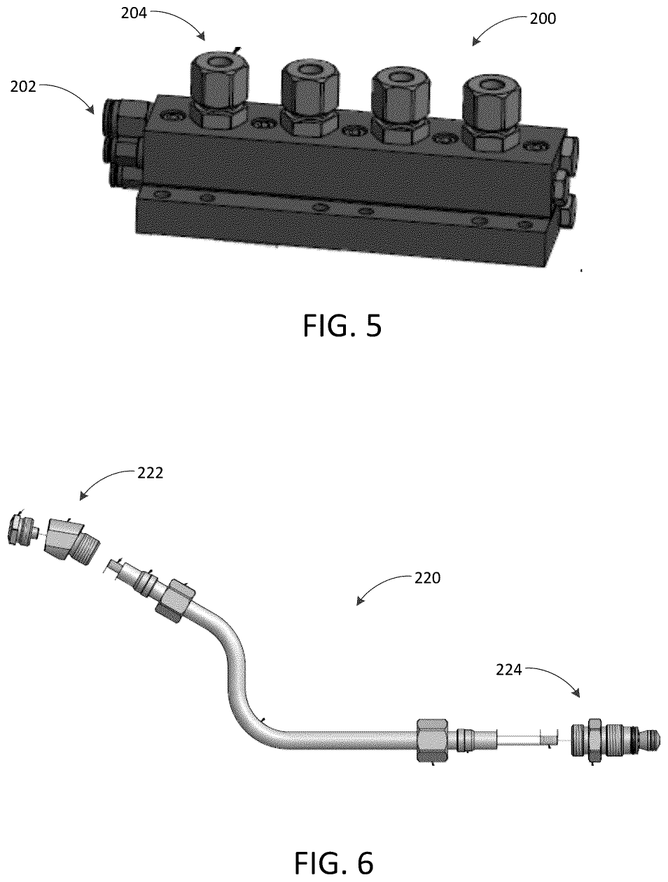

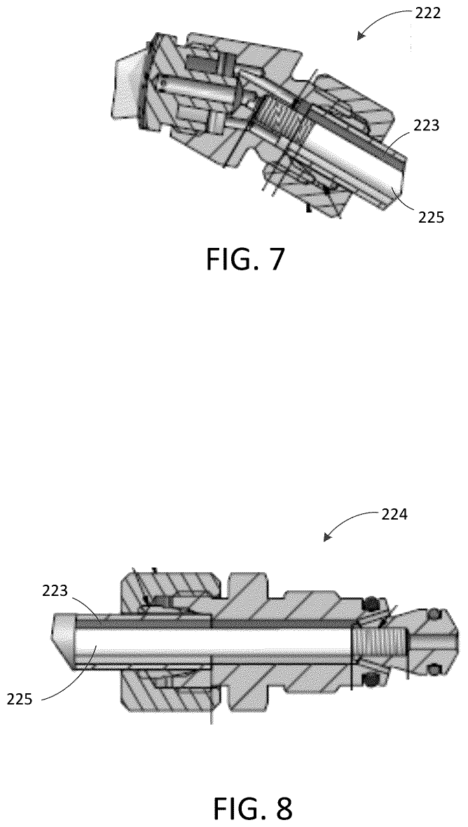

In an embodiment, multiple cooling modules 131 may share a common spray head, while still maintaining individual nozzles for each cooling module 131. FIG. 5 shows an embodiment of a spray head (or an ablate and/or cooling head) 200 that can be used for four (4) cooling modules 131. The spray head 200 can include inlet connections 202 to receive the ablating material and/or cooling fluids to be provided by corresponding cooling modules 131. The spray head 200 can also include outlet connections 204 that can receive a corresponding nozzle for each cooling module 131. In an embodiment, the spray head 200 can be located in the module equipment box 160 and the outlet connections 204 can be connected to the nozzle for each cooling module 131 at the end-effector 130 by corresponding tubing in the module connectors 162. FIG. 6 shows an exploded view of an embodiment of a spray nozzle 220 that can be used for each cooling module 131. The spray nozzle 220 can have a nozzle end 222 and a connection end 224 that can mate with an outlet connection 204 of the spray head 200 or mate with corresponding tubing connected to the outlet connection 204 when the spray head 200 is located in the module equipment box 160. FIG. 7 shows a cross-sectional view of an assembled nozzle end 222 and FIG. 8 shows a cross-sectional view of an assembled connection end 224. In an embodiment, both the nozzle end 222 and the connection end 224 can include an air passageway 223 and a water passageway 225. The supply of air via the air passageway 223 and the supply of water via the water passageway 225 can be individually controlled by the spray head 200 such that the nozzle can provide only air, only water or atomized water. When a shared spray head 200 is used for several cooling modules 131, the spray head 200 may provide individual control to each outlet connection 204 (i.e., each outlet connection 204 may be individually turned on and off (based on instructions from the controller 150) and/or each outlet connection 204 may receive a different ablating material or cooling fluid). In other embodiments, some (or all) of the outlet connections 204 may be controlled together (i.e., several (or all) outlet connections 204 may be turned on and off together (based on instructions from the controller 150) and/or several (or all) outlet connections 204 may receive the same ablating material or cooling fluid).

In the cooling modules 131, the rate and pressure of delivery of the ablating material and/or cooling fluid by the spray nozzles 220 can be adjusted by the controller 150 to ensure that the ablating material and/or cooling fluid arrives at the casting component's exterior or interior surfaces directly through the mold or through an aggregate first by percolation through the mold 110, arriving at the casting ahead of the arrival of the main spray. In this way, the molten alloy metal is enabled to develop a sufficiently solid fraction in the metal alloy surface or skin and generate sufficient strength by primary cooling or by primary and secondary cooling of the ablate media prior to the application of the full force of the main primary and secondary ablate cooling spray. In other embodiments, the manner in which the ablating material and/or cooling fluid is delivered to the mold 110 (e.g., narrow stream, wide fan, steady flow, intermittent pulse, etc.), by the cooling modules 131 can affect the rate and pressure settings for the cooling modules 131 accordingly.

In one embodiment, the cooling modules 131 may begin the application of the ablating material and/or cooling fluid at the base of the mold 110. The end-effector 130 can then be moved in a progressive manner to permit the cooling modules 131 to deliver the ablating material and/or cooling fluid to intact portions of the mold 110 or in other cases so that the mold 110 entirely decomposes. In other embodiments, the end-effector 130 may be positioned such that the cooling modules 131 direct the ablating material and/or cooling fluid to the middle of the mold 110, the top of the mold 110, or at some other desired location of the mold 110. The end-effector 130 can then be moved at a translation maximum speed of the robotic arm 140 enabling a dwell time of the ablate material at a location of the mold 110 (e.g., a local area of 700 μm²) to be present for 1 millisecond or less.

When an array of cooling modules 131 is present in the end-effector 130, the number of cooling modules 131 that may be active can be varied from a single cooling module 131 to all of the cooling modules 131 depending on the mold 110, the part to be cast and/or the particular stage or requirements of the solidification process. The controller 150 can control the robotic arm 140 to move the end-effector 130 to different horizontal (e.g., x-axis), vertical (e.g., y-axis) and height or depth (e.g., z-axis) positions relative to the mold 110, as needed during the solidification process, to permit complete coverage of the mold 110 and cast component by the cooling modules 131 (and the other modules of the end-effector 130).

In addition, when multiple cooling modules 131 are present, the controller 150 can control the operation of individual cooling modules 131 to coordinate the function of the cooling modules 131 to complement one another. For example, when the end-effector 130 is moved to a stationary position, an array of cooling modules 131 may be coordinated to switch on and off to cause a spray to move across the surface of the mold 110 to create progressive ablation through the mold or of the mold 110 and the component part to be solidified or cast. Alternatively, the number of active cooling modules 131 may be adjusted as the end-effector 130 is moved about the mold 110, as needed, during the solidification process to provide the desired characteristics associated to controlling the state of change of the alloy metal creating the solidified component part.

In one embodiment, the ablating material and/or cooling fluid can be supplied to each of the cooling modules 131 at either a constant or varying pressure and a constant or varying rate by a pump (not shown) that can be controlled via the controller 150. The controller 150 can also be used to activate cooling modules 131 in the desired sequence and for the desired time. Conventional pumps can be utilized that can be suitably regulated by the controller 150 to achieve the desired fluid delivery rates and pressures for the cooling modules 131, whether they be varying or constant.

As the ablating material and/or cooling fluid makes contact with the mold 110 and the component or part to be cast, which exhibits both endothermic and exothermic processes, the ablating material and/or cooling fluid can be converted to a different state (e.g., steam if water is used as the ablating material and/or cooling fluid). The absorption of latent heat or energy from the part to be cast by the ablating material and/or cooling fluid during the solidification process results in an ejection force in the converted ablating material and/or cooling fluid, whose extraction from the area (e.g., the surface of the part to be cast) is aided by the vacuum/airflow modules 133. However, in other embodiments, if the ablating material and/or cooling fluid is a gas then vacuum/airflow modules 133 may not be included in the end-effector 130 or the vacuum/airflow modules 133 may be deactivated and not used, if present, in the end-effector 130.

The energy module 135 can be used to place additional energy into the mold 110 prior, during or after filling of the mold 110 and put energy back into the system (i.e., the mold 110 and the alloy metal itself during filling or after the component or part is cast or is to be cast). As the cooling modules 131 remove the mold 110 and expose the part or component to be cast, there may be situations during the solidification process where energy or heat has to be reintroduced into the part to be cast by the energy module 135 to either slow or reverse the solidification process. In other embodiments, the energy module 135 may be used in combination with the supply module 139 (e.g., following the alloy metal liquid moving front in the mold 110) in order to keep the alloy metal with sufficient super heat or energy above any solid fraction to maintain the alloy metal in a molten state when attempting to cast long, thin parts. The energy module 135, in one embodiment, can apply various wavelength infrared (IR) heating to the mold 110 depending on the mold structure and type and the component or part to be cast. For example, a tubular mold structure can enable certain wavelengths of short wave IR to pass through a wall chamber that is 100 μm to 500 μm in diameter. However, in other embodiments, the energy module 135 may apply hot air or use direct flame impingement (e.g., natural gas, a welding or acetylene torch, or other gases sufficient in energy).

The sensing module 137 can be used to obtain temperature measurements and/or vision location measurements of the component or the component and the mold 110 and/or the component part to be cast and provide the temperature and/or location measurement information to the controller 150. The controller 150 can then use the temperature and/or location information to control and/or make adjustments to the operation of the end-effector 130 (e.g., slow or stop a cooling module 131 and/or activate an energy module 135). The sensing module 137 can be an infrared (IR) thermal image camera (e.g., a FLIR A500f/A700f thermal camera) in one embodiment. In other embodiments, the sensing module 137 can include a digital camera and/or a probe (e.g., a thermocouple) that can be used for a contact measurement (i.e., the probe touches the component to be measured) or a close proximity measurement (i.e., the probe is near, but not touching, the component to be measured). The probe may be spring mounted in the sensing module 137 such that the probe can be positioned at an appropriate position relative to the component. The sensing module 137 may be positioned in the end-effector 130 such that the temperature of the component can be sensed after the cooling modules 131 have been used. A combination of both a sensor probe and infrared (IR) thermal image camera can work in concert with each other prior, during or after solidification for calibration and/or control use.

In another embodiment, the sensing module 137 can incorporate measurement system devices that can work individually or interactively to collect dimensional information about the part or component during the casting and solidification processes. For example, dimensional information can be collected regarding liquid to solid transitions and contraction of the alloy, which can include information and observations associated with surface characteristics and characterization. In addition, in some embodiments, the sensing module 137 may be incorporated into a second end-effector 130 that has a fixed position relative to the mold 110 to permit more effective calibration of a thermal camera and/or more accurate positioning of probes. The fixed position of the second end-effector 130 (and sensing module 137) may be adjusted during the casting process to a new fixed position relative to the mold depending on the size of the mold and/or the casting process being performed.

The supply module 139 can be used to supply molten alloy metal to the mold 110. In an embodiment, the supply module 139 can incorporate appropriate pumps and valves to move the molten alloy metal from its source to the mold 110. Some examples of pumps that may be used in the supply module 139 can include molten metal transfer pumps, gravity feed pumps, counter- or anti-gravity feed pumps, electromagnetic pumps or any other suitable type of pump. In one embodiment, the supply module 139 can include a pinch valve that can control the flow of the molten alloy metal. Additional information regarding the operation of the pinch valve can be found in U.S. patent application Ser. No. 18/745,690, entitled “Flexible Sleeve, and Devices and Methods Incorporating the Same,” and filed on Jun. 17, 2024, which application is incorporated herein by reference in its entirety.

The supply module 139 can be used to initially supply molten alloy metal to the mold 110, and once the mold 110 has been filled, then the cooling modules 131 may be used for the solidification process. In other embodiments, the supply module 139 can be used to fill one portion of the mold 110, while at the same time, the cooling modules 131 can be used to solidify other previously filled portions of the mold 110. In further embodiments, the supply module 139 can be used to supply a different molten alloy metal to the mold 110 (e.g., a secondary fill), after the mold 110 has been filled with an initial primary molten alloy metal (e.g., a primary fill) to produce a part incorporating two different metals without having to weld the different metals together. In addition, in some embodiments, the supply module 139 may be incorporated into a second end-effector 130 that has a fixed position relative to the mold 110 to provide more stable conditions for supplying molten alloy metal to the mold 110.

The robotic arm 140 can be used to control the position of the end-effector 130 relative to the mold 110. In one embodiment, the robotic arm 140 can be a 7-axis robot that can hold between 7-10 pounds. However, other configurations of the robotic arm 140 are possible in other embodiments as the robot lift capacity and the mass carried can be increased.

The controller 150 can be connected to the robotic arm 140 and the end-effector 130 (either directly or via the module equipment box 160) to control operation of both the robotic arm 140 and the modules of the end-effector 130. In one embodiment, the controller 150 can control movement of the robotic arm 140 and operations of the modules of the end-effector 130 according to a predefined sequence (e.g., the robotic arm 140 moves to a preselected position relative to the mold 110 and activates a module for a preselected time period). In other embodiments, the controller 150 can dynamically control the movement of the robotic arm 140 and the operation of the modules of the end-effector 130 based on feedback provided by one or more sensors located around the robotic system 100 (e.g., the sensing modules 137 in the end-effector 130). For example, the controller 150 may alter the operation of the cooling modules 131 (i.e., increase or decrease cooling or cooling capacity or move and translate the end-effector 130 simultaneously with changing cooling capacity) depending on the sensed temperature of the part to be cast and the mold 110.

In one embodiment, the end-effector 130 can incorporate all necessary modules to perform the steps of the casting solidification process. However, in other embodiments, multiple end-effectors 130 associated with different robotic arms 140 can be used in tandem. For example, one end-effector 130 may incorporate cooling modules 131 and vacuum/airflow modules 133, while a second end-effector may incorporate energy modules 135 and sensing modules 137.

In some embodiments, the arrangement of modules in the end-effector 130 can be tailored for the particular thickness or size of the part to be cast. For example, when the casting modulus is 1.5 millimeters (mm) or a plate 3 mm or less is being cast, the end-effector 130 may only have one cooling module 131 that can be surrounded on each side by vacuum/airflow modules 133. A sensing module 137 may be located next to a vacuum/airflow module 133 and then followed by an energy module 135. The energy module 135 may then be followed by another sensing module 137 to provide a thermal or vision management input to the controller 150 regarding the operation of the energy module and determine if the part to be cast is being heated. In another example, a thicker part to be cast may utilize an end-effector 130 that does not have an energy module 135.

In other embodiments, multiple energy modules 135 may be incorporated into the end-effector 130 and used to apply different treatments to the part to be cast. The energy modules 135 can be used to arrest cooling as the part to be cast enters the liquidus temperature to control solid fraction percentage and provide optimization of solid fraction growth or a reduction in time is desired for the alloy metal prior to the solidifying alloy exiting the solidus and either continues to cool to room temperature or is interrupted above the solvus or is quenched to a solid to solid conversion desired by the alloy metal and cooling time temperature requirements. By arresting the cooling, the component or part that is to be cast or is cast is allowed to homogenize or go below the homogenization temperature into a solution state. The arresting of the cooling can also be used to provide a desired sensitization to some alloys such as an aluminum 5XXX series or 5XX series. In the solution state, there can be an interstitial liquid (e.g., magnesium solutes) while the main portion of the component part is solid alpha aluminum as in the cast state, or rather the solid state. While the part is held in the solution state, a quench can be performed on the part using the energy modules 135 to add heat to the part and also to remove energy from the component part. After the quench is completed on the component or part, the energy modules 135 may be used again to create a post thermal treatment artificial age by heating the part to provide a low temperature artificial aging process on the component part. In still other embodiments, when a support network is incorporated into the mold 110, the support network may be used as a pathway for the energy modules 135 to provide heat to the part or the cooling modules 131 to provide the ablating material and/or cooling fluid to the part.

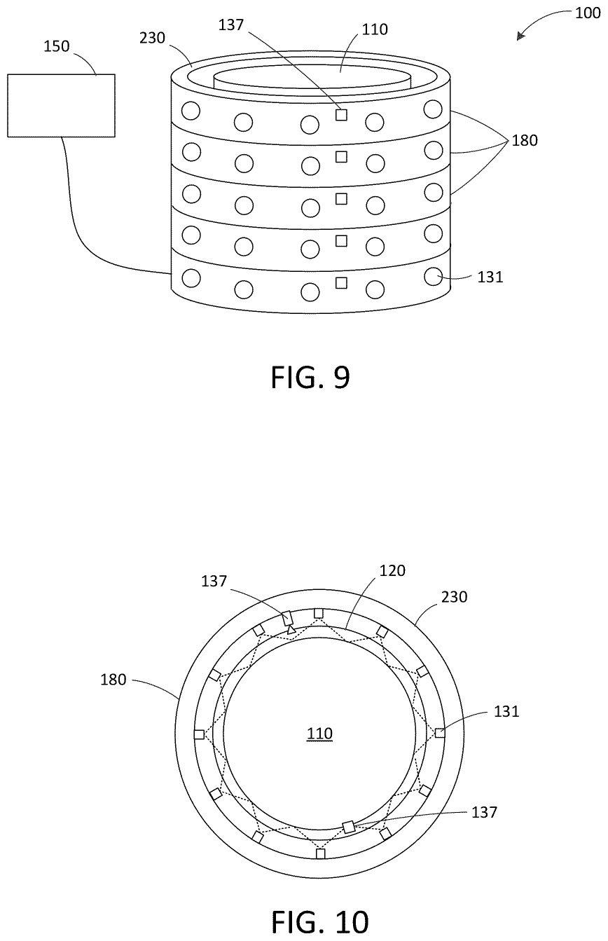

FIGS. 9 and 10 show another embodiment of the system 100 that may be used when the mold 110 and/or the component or part to be cast has a rounded or circular horizontal cross-sectional shape (e.g., the component or part to be cast has a generally cylindrical shape such as a wheel for a vehicle). The end-effector 230 can have a cylindrical tube shape with a corresponding height such that the circumferential surface of the mold 110 is completely surrounded or enclosed by the end-effector 230. Operation of the end-effector 230 can be controlled by the controller 150. In some embodiments, the end-effector 230 may incorporate the end devices for the modules (e.g., nozzles for the cooling module 131) with the remaining portion of the module being incorporated into one or more module equipment boxes 160 (not shown in FIGS. 9 and 10). As previously discussed, the end device of a module can be connected to the module equipment box 160 by one or more corresponding module connections 162 (not shown in FIGS. 9 and 10).

In an embodiment, the end-effector 230 can be arranged into a series of circuits or zones 180 for the modules of the end-effector 230. The zones 180 of the end-effector 230 can be stacked or arranged vertically to a height corresponding to the height of the mold 110. Each zone 180 can include a series of cooling modules 131 arranged around the interior surface of the end-effector 230 (see FIG. 10) such that the spray from the nozzles 220 of the cooling modules 131 covers (or substantially covers) the outer circumference of the mold 110. To ensure that the spray from the nozzles 220 of the cooling modules 131 covers the outer circumference of the mold 110, the nozzles 220 may be able to rotate to provide additional coverage on the outer circumference of the mold 110. In an embodiment, the nozzles 220 of the cooling modules 131 for each zone 180 can be vertically aligned. However, in other embodiments, the nozzles 220 of the cooling modules 131 for each zone 180 may be offset vertically.

In addition, each zone 180 may include one or more sensing modules 137 placed around the interior surface of the end-effector 131. The sensing modules 137 in each zone can include one or more thermal image cameras and/or one or more probes. Similar to the nozzles 220 of the cooling modules, the end devices of the sensing modules 137 for each zone 180 can be vertically aligned, but may also be offset vertically. While not shown in FIGS. 9 and 10, the end-effector 230 may also include other type modules (e.g., energy modules 135 or vacuum/airflow modules 133) depending on the casting process being used, the component or part being cast, and/or the mold 110.

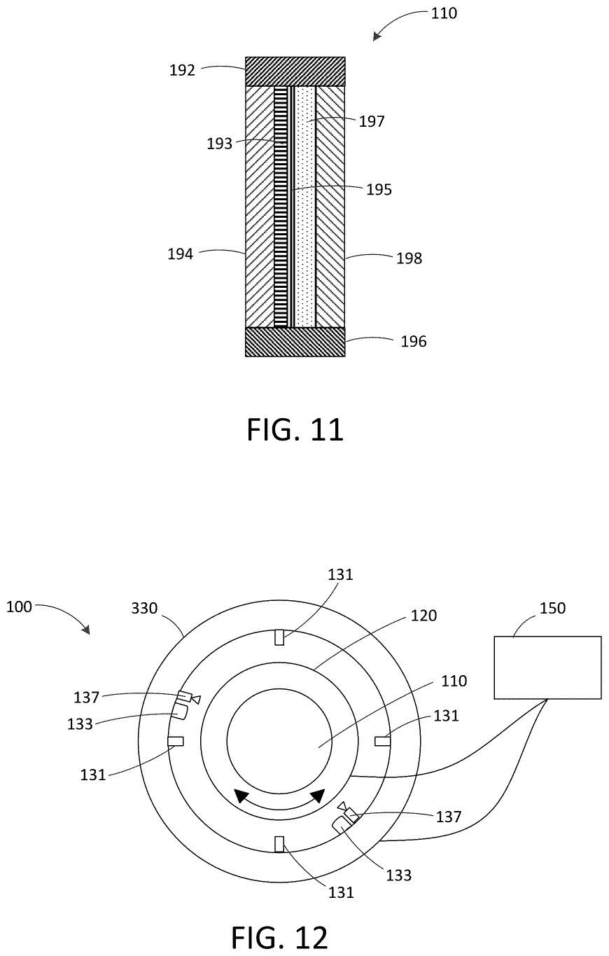

FIG. 11 shows a partial cross-section of one embodiment of the mold 110 used with end-effector 230 from FIGS. 9 and 10. The mold 110 can include an upper tool 192, an outer tool 194, a lower tool 196 and an inner tool 198. The outer tool 194 is positioned adjacent to the cooling modules 131 (not shown in FIG. 11), i.e., the outer tool 194 is directly impinged by the spray from the cooling modules 131, and the inner tool 198 is located opposite the outer tool 194 and the cooling modules 131, i.e., the inner tool 198 is not directly impinged by the spray from the cooling modules 131. In an embodiment, the outer tool 194 and the inner tool 198 can be formed from an ablatable material and have a thickness between 100 μm and 2000 μm. In another embodiment, the inner tool 198 may be a solid material that cannot be ablated.

FIG. 11 also shows the mold 110 after being filled with molten alloy and partially completing the solidification process. The solidification process for the molten alloy starts from the outer tool 194 and progresses toward the inner tool 198. During the solidification process, the molten alloy supplied to the mold 110 is first solidified in the area 193 near the outer tool 194, is partially solidified in the area 195 next to the solidified area 193 and is still in a molten state in the area 197 near the inner tool 198. In one embodiment, the solidification process can involve activating all of the cooling modules 131 (each of which has a constant output) in all of the zones 180 at the same time to provide cooling and/or solidification of the molten alloy in the mold from the outer tool 194 to inner tool 198. In another embodiment, the cooling modules 131 in one zone are sequentially activated from top to bottom. In other words, the cooling modules 131 in the zone 180 nearest to the upper tool 192 would be activated first followed by the activation of the cooling modules 131 in each adjoining zone 180 (after deactivation of the cooling modules 131 in the previous zone 180) until the cooling modules 131 in the last zone 180 nearest the lower tool 196 are activated. The sequential activation of the cooling modules 131 in each zone 180 can provide for directional solidification from top to bottom in the mold 110. The sensing modules 137 can be used to determine the temperature of the alloy in the mold and control when to activate the cooling modules 131 in the next zone 180.

In still another embodiment, the end-effector 230 can have an “inner” portion (i.e., a portion adjacent to the inner wall 198 of the mold 110) with zones 180 corresponding to those in the “outer” portion of the end-effector 230 (i.e., the part of the end-effector 230 shown in FIGS. 9 and 10). The each of the zones 180 of the “inner” portion of the end-effector 230 may include cooling modules 131, vacuum/airflow modules 133, sensing modules 137 and/or energy modules 135. The modules of the zones 180 of the inner portion of the end-effector 230 may be controlled in a manner similar to the modules in the “outer” portion of the end-effector 230. For example, cooling modules 131 located in the “inner” portion of the end-effector 230 may be activated simultaneously with cooling modules 131 in the “outer” portion of the end-effector 230 when cooling on both sides of the mold 110 is desired. In addition, energy modules 135 of the inner portion of the end-effector 230 may be activated as needed (e.g., based on temperature measurements, which cooling modules 131 and zones 180 are active and/or elapsed time) to provide heat to the inner wall 198 so that unwanted solidification of the molten alloy is prevented when directional cooling is desired.

FIG. 12 shows a further embodiment of the system 100 that may be used when the mold 110 and/or the component or part to be cast has a rounded or circular horizontal cross-sectional shape. The system 100 is similar to the system from FIGS. 9-11, except that end-effector 330 can incorporate fewer modules per zone 180 than end-effector 230 and the table 120 can rotate or oscillate. The end-effector 330 may only include a preselected number of modules for each zone 180 such that the modules for a zone do not provide complete coverage about the outer circumference of the mold 110. In addition, the mold 110 may be rotated or oscillated by the table 120 to enable the modules for a zone to provide complete coverage of the outer circumference of the mold 110. As shown in the embodiment of FIG. 12, the end-effector 330 may include, for each zone 180, only 4 cooling modules 131 that are positioned 90 degrees apart. When the cooling modules 131 are spaced 90 degrees apart, the table 120 can rotate or oscillate a quarter turn (or 90 degrees) in order for the spray from the cooling modules 131 to cover the outer circumference of the mold 110. However, in other embodiments, fewer than four (4) cooling modules 131 (e.g., two (2)) or more than four cooling modules (e.g., eight (8)) may be used in each zone 180 with corresponding changes to the amount of rotation or oscillation needed from the table 120 to provide coverage for the outer circumference of the mold 110.

The end-effector 330 may also include, for each zone 180, sensing modules 137 and airflow/vacuum modules 133. The controller 150 can control operation of the modules of the end-effector 330 and the operation of the table 120. The controller 150 can control the speed and direction of rotation for the table 120. In one embodiment, the controller 150 can rotate (or oscillate) the table at a preselected speed for a preselected time period, while simultaneously controlling operation of the modules of the end-effector 130. In another embodiment, the controller 150 can control operation of the table 120 (e.g., speed of rotation and/or direction of rotation) based on feedback information. The controller 150 may receive information on the position of the table 120 (relative to a preselected position) from a sensor incorporated into the table 120 and/or from sensing modules 137 and control the direction of rotation or oscillation based on the position information. In addition, the sensing modules 137 may provide temperature information about the mold and/or the part or component to be cast to the controller 150 and the controller 150 can then control the speed of rotation of the table 120 (and the mold 110) to prevent the occurrence of overcooling or undercooling of the part or component to be cast. It should be noted that the system 100 can differ from a die casting system. In a die casting system, the tool is cooled after casting to remove the energy when solidifying the cast part. In contrast, the system 100 can extract and introduce energy before, during, and after casting through the tool or mold 110, in addition to introducing energy to the tool, and also extracting energy from the tool or mold 110.

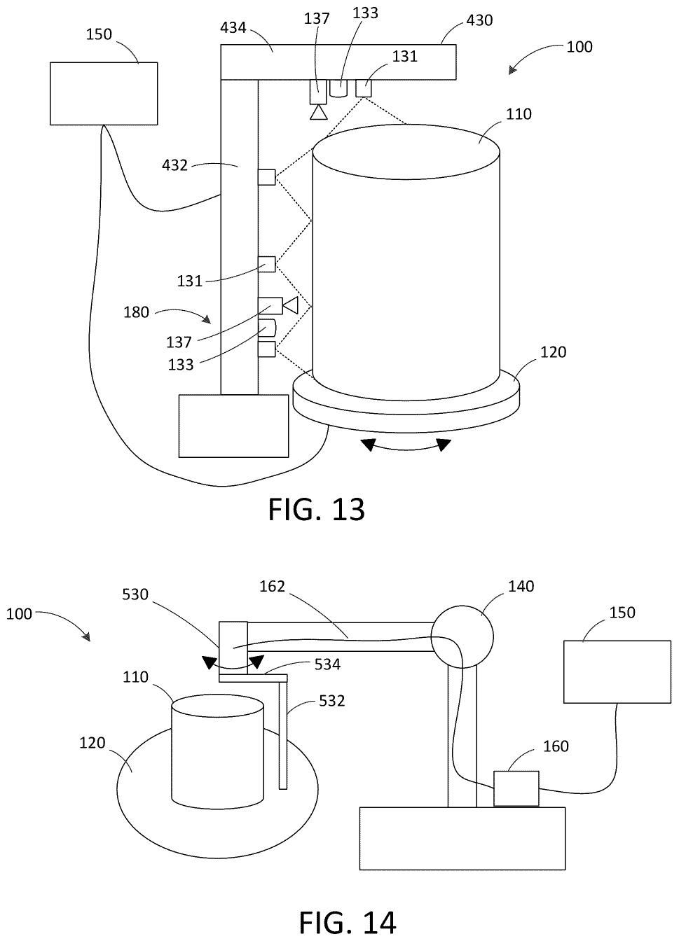

FIG. 13 shows yet another embodiment of the system 100 that may be used when the mold 110 and/or the component or part to be cast has a rounded or circular horizontal cross-sectional shape. The system 100 is similar to the system from FIG. 12, except that end-effector 430 is arranged as a column 432 with a cross-member 434 extending over the mold 110 and the table 120. The end-effector 430 may include zones 180 corresponding to areas in both the column 432 and the cross-member 434 and each zone can incorporate different module types. However, in an embodiment, only 1 module of each module type can be incorporated in a zone. For example, a zone 180 on the column 432 may include one cooling module 131, one sensing module 137 and one vacuum/airflow module 133. In addition, the mold 110 may be rotated in a full circle (or 360 degrees) or oscillated in a half-circle (or 180 degrees) in each direction by the table 120 to enable the modules for a zone 180 to provide complete coverage of the outer circumference of the mold 110.

The controller 150 can control operation of the modules of the end-effector 430 and the operation of the table 120. The controller 150 can control the speed and direction of rotation for the table 120. In one embodiment, the controller 150 can rotate (or oscillate) the table at a preselected speed for a preselected time period, while simultaneously controlling operation of the modules of the end-effector 130. In another embodiment, the controller 150 can control operation of the table 120 (e.g., speed of rotation and/or direction of rotation) based on feedback information. The controller 150 may receive information on the position of the table 120 (relative to a preselected position) from a sensor incorporated into the table 120 and/or from sensing modules 137 and control the speed and/or direction of rotation or oscillation based on the position information. In addition, the sensing modules 137 may provide temperature information about the mold and/or the part or component to be cast to the controller 150 and the controller 150 can then control the speed of rotation of the table 120 (and the mold 110) to prevent the occurrence of overcooling or undercooling of the part or component to be cast. In an alternate embodiment, the end-effector 430 may be rotated around the table 120 or rotated in conjunction with rotation or oscillation of the table 120.

FIG. 14 shows an additional embodiment of the system 100 that may be used when the mold 110 and/or the component or part to be cast has a rounded or circular horizontal cross-sectional shape. The system 100 is similar to the system from FIG. 13, except that the table 120 is stationary and the end-effector 530 is mounted on the robotic arm 140 and can rotate in a full circle (or 360 degrees) or oscillate in a half-circle (or 180 degrees) around the mold 110. Similar to end-effector 430 in FIG. 13, end-effector 530 can include a vertical portion 532 (similar to column 432) and a horizontal portion 534 (similar to cross-member 434). The end-effector 530 may include zones corresponding to areas in both the vertical portion 532 and the horizontal portion 534 and each zone can incorporate different module types. However, in an embodiment, only 1 module of each module type can be incorporated in a zone. The end-effector 530 may be rotated (in a full circle) or oscillated (in a half-circle in each direction) to enable the modules for a zone to provide complete coverage of the outer circumference of the mold 110.

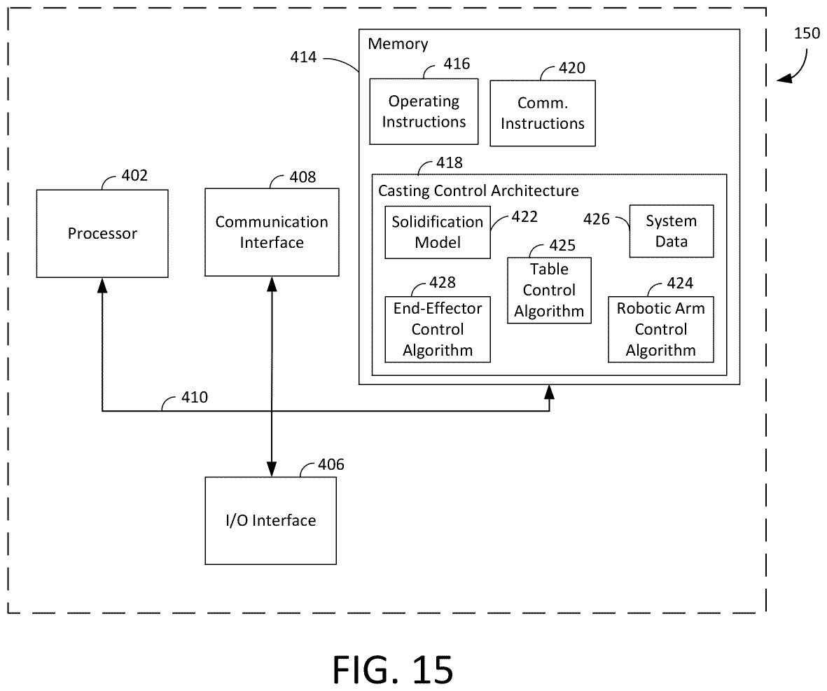

FIG. 15 shows an embodiment of a controller 150 that can be used with the system 100. Although controller 150 may include any suitable components, in one embodiment, controller 150 may include a processor 402, an input/output (I/O) interface 406, a communication interface 408, internal communication interface 410 and memory 414.

Processor 402 may control the operations of the other components of controller 150 and may include any suitable processor. A processor 402 may include any suitable processing device such as a general-purpose processor or microprocessor executing instructions from memory, hardware implementations of processing operations (e.g., hardware implementing instructions provided by a hardware description language), any other suitable processor, or any combination thereof. In one embodiment, processor 402 may be a microprocessor, a central processing unit (CPU) or a digital signal processor (DSP) that includes processing hardware to execute instructions stored in memory 414. Memory includes any suitable volatile or non-volatile memory capable of storing information (e.g., instructions and data for the operation and use of controller 150), such as RAM, ROM, EEPROM, flash, magnetic storage, hard drives, any other suitable memory, or any combination thereof. The processor 402 communicates with and drives the other elements within the controller 150 via an internal communication interface 410, which can include at least one bus.

The controller 150 can also include an input/output (I/O) interface 406 to receive inputs from a user of the controller 150 and to provide outputs to a user of the controller 150 as may be desired. Communication interface 408 may be in communication with processor 402 via the internal communication interface 410 and may provide for wireless or wired communications with the other components of the system 100 (e.g., end-effector 130, modules, robotic arm 140, table 120, module equipment boxes 160, etc.). In one embodiment, communication interface 408 may include a wireless interface that communicates using a standardized wireless communication protocol (e.g., WiFi, ZigBee, Bluetooth, Bluetooth low energy, etc.) or proprietary wireless communication protocol operating at any suitable frequency such as 900 MHz, 2.4 GHZ, or 5.6 GHZ. As described herein, a suitable wireless communication protocol may be selected or designed for the particular signal path between the controller 150 and the other component of the system 100. In some embodiments, communication interface 408 may be a wired interface that provides an interface with wired connections to the other components of the system 100 to allow processor 402 to communicate with the other components of the system 100 as described herein. The wired connection may be any suitable wired connection to facilitate communication via any suitable protocol.

In one embodiment, memory 414 of central monitoring system 12 may include memory for executing instructions with processor 402, memory for storing data, and a plurality of sets of instructions to be executed by processor 402. Although memory 414 may include any suitable instructions, in one embodiment the instructions may include operating instructions 416 for generally controlling the operation of the controller 150, a casting control architecture or system 418 to control operation of the components of the system 100 during the casting and solidification process, and communication instructions 420 to facilitate communications with the components of the system 100 via communication interface 408.

The casting control architecture 418 can also include logic 422, referred to herein as “a solidification model,” logic 424, referred to herein as “a robotic arm control algorithm,” logic 428, referred to herein as “an end-effector control algorithm,” and logic 425, referred to herein as “a table control algorithm.” In other embodiments, the solidification model 422, the robotic arm control algorithm 424, the end-effector control algorithm 428 and/or the table control algorithm 425 can be combined with the operating instructions 416 or with one another. The operating instructions 416, the communication instructions 420, the solidification model 422, the robotic arm control algorithm 424, the end-effector control algorithm 428 and/or the table control algorithm 425 can be implemented in software, hardware, firmware, or any combination thereof. In the controller 150 shown by FIG. 15, the operating instructions 416, the communication instructions 420, the solidification model 422, the robotic arm control algorithm 424, the end-effector control algorithm 428 and/or the table control algorithm 425 can be implemented in software and stored in memory 414. When the operating instructions 416, the communication instructions 420, the solidification model 422, the robotic arm control algorithm 424, the end-effector control algorithm 428 and/or the table control algorithm 425 are implemented in software, the processor 402 may execute instructions of the operating instructions 416, the communication instructions 420, the solidification model 422, the robotic arm control algorithm 424, the end-effector control algorithm 428 and/or the table control algorithm 425 to perform the functions ascribed herein to the corresponding components. However, other configurations of the operating instructions 416, the communication instructions 420, the solidification model 422, the robotic arm control algorithm 424, the end-effector control algorithm 428 and/or the table control algorithm 425 are possible in other embodiments.

Note that the operating instructions 416, the communication instructions 420, the solidification model 422, the robotic arm control algorithm 424, the end-effector control algorithm 428 and/or the table control algorithm 425, when implemented in software, can be stored and transported on any computer-readable medium for use by or in connection with an instruction execution apparatus that can fetch and execute instructions. In the context of this document, a “computer-readable medium” can be any non-transitory means that can contain or store code for use by or in connection with the instruction execution apparatus.

In addition, the casting control architecture 418 may also store data 426 about the system 100 that can be used by the solidification model 422, the robotic arm control algorithm 424, the end-effector control algorithm 428 and the table control algorithm 430 during a solidification process. The system data 426 can include information and data about the components of the system 100 (e.g., operating parameters of the cooling modules 131 or movement capabilities of the robotic arm 140). System data 426 can also include information regarding operation of the system 100 (e.g., temperature measurements, position measurements, etc.) that is received as feedback from the components of the system 100 (e.g., sensing modules 137) via the communication interface 408 during the casting process.

The solidification model 422 can be used to apply a desired solidification process to the mold 110 and the part or component to be cast, which may include processes other than cooling such as heating via energy module 135. In an embodiment, the solidification model 422 can incorporate numerous solidification processes for different types of molds 110 and/or parts or components being cast. For example, different solidification process may be used based on the shape of the part or component to be cast (e.g., round versus polygonal) and/or the dimensions of the part or component to be cast (e.g., thick versus thin). In an embodiment, the solidification processes that can be implemented by the solidification model 422 may be selected by a user via the I/O interface 406. Once a solidification process has been selected, the solidification model 422 can provide data and/or instructions to the robotic arm control algorithm 424, the end-effector control algorithm 428 and/or the table control algorithm, as needed, to implement the selected solidification process.

The robotic arm control algorithm 424 can be used to position the robotic arm 140 to a desired position relative to the mold 110 and table 120 based on the solidification process being implemented by the solidification model 422 and/or system data 426. The robotic arm control algorithm 424 can be used to position the robotic arm 140 to specific coordinates (e.g., x, y and z coordinates) in the space surrounding the mold 110 and the table 120. In addition, the robot arm control algorithm 424 can be used to control the speed of movement of the robotic arm 140 (and the speed of movement of the end-effector 130) based on the solidification process being implemented by the solidification model 422 and/or system data 426.

The end-effector control algorithm 428 can be used to control the operation of the modules incorporated into the end-effector 130 based on the solidification process being implemented by the solidification model 422 and/or system data 426. The end-effector control algorithm 428 can be used to activate and/or deactivate particular modules in the end-effector 130 based on the solidification process being implemented by the solidification model 422 and/or system data 426 . . . . For example, the end-effector control algorithm 428 can activate cooling modules 131 during a cooling portion of a solidification process being implemented by the solidification model 422. After the cooling portion is complete, the end-effector control algorithm 428 can deactivate the cooling modules 131, take a temperature measurement with sensing modules 137 and activate energy modules 135 for a subsequent portion of the solidification process. In addition, the end-effector control algorithm 428 can be used to control the specific operation of the modules of the end-effector 130 (e.g., the amount of cooling provided by a cooling module 131 when operating) based on the solidification process being implemented by the solidification model 422 and/or system data 426.

The table control algorithm 430 can be used to control the speed and/or direction of rotation of the table 120 based on the solidification process being implemented by the solidification model 422 and/or system data 426. The table control algorithm 430 can be used to rotate the table in a specific direction (e.g., clockwise or counter-clockwise) to position the mold 110 relative to the end-effector 130. In addition, the table control algorithm 430 can be used to control the speed of movement of the table 120 (and the speed of movement of the mold 110) based on the solidification process being implemented by the solidification model 422 and/or system data 426.

In an embodiment, the solidification model 422 can incorporate a time parameter based on the speed of movement of the end-effector 130 (via the robotic arm 140) or movement of the table 120 into solidification processes. The speed of movement of the end-effector 130 or the table 120 can be used to provide a pulsation effect when operating the cooling modules 131 in a side-to-side (horizontal) or up-and-down (vertical) motion. The pulsation effect provided by the cooling modules 131 from the movement of the end-effector 130 or the table 120 can be in addition to any pulsation provided by the on/off switching of the cooling modules 131. Movement of the end-effector 130 or table 120 over a distance of 100 μm can occur in 1 millisecond which provides the pulse time (i.e., on and off) when translating the end-effector 130 in both directions. The pulse can be controlled by the movement speed of the robotic arm 140. The robotic arm 140 can reach speeds of 1 meter per second with high accuracy and up to 4.4 meters per second.

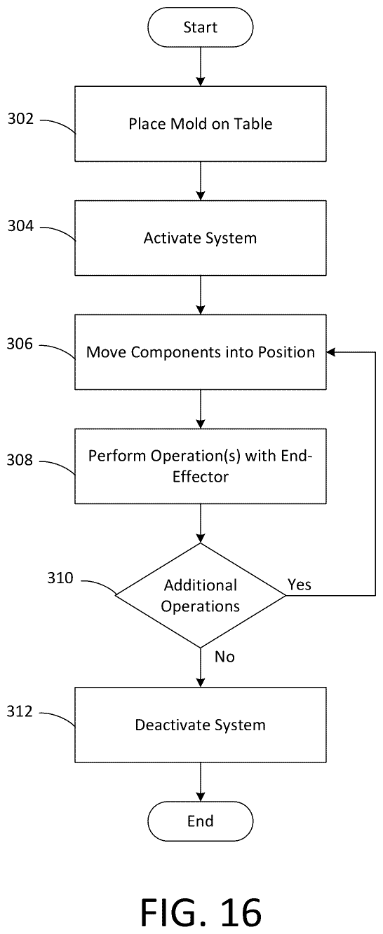

FIG. 16 shows an embodiment of a solidification process that can be implemented by the system 100. The process begins with the mold 110 being placed on the table 120 (step 302). In one embodiment, the mold 110 can already be filled with molten alloy metal when placed on the table 120. However, in other embodiments, the mold 110 may be filled with molten alloy metal after being placed on the table (e.g., by supply module 139 of end-effector 130). After the mold 110 is position on the table 120, the system 100 can be activated by the controller 150 (step 304). Activation of the system 100 can involve the controller 150 performing any initialization steps or procedures needed to prepare the components of the system 100 (e.g., robotic arm 140, end-effector 130, etc.) for the solidification process. Some examples of initialization steps that may be needed are the providing of power and/or materials (e.g., water, air, etc.) to the components of the system 100. In addition, the selection of the solidification process to be performed by the system 100 can be included as part of the activation procedure.

Once the system 100 has been activated and the solidification process to be applied has been selected, the controller 150 can move the components of the system 100 into a position for the selected solidification process (step 306). After activation of the system 100, the controller 150 can initially move the components of the system 100 into a starting position (e.g., move the robotic arm 140 and end-effector 130 to an end of the mold 110) and then subsequently move the components of the system 100 into other positions as set forth by the selected solidification process (e.g., move the robotic arm 140 and end-effector 130 from one end of the mold 110 toward the other end of the mold 110). After the components of the system 100 have been moved into the appropriate position, the end-effector 130 can perform the corresponding operation for that position as set forth in the solidification process (step 308).

In one embodiment, the performed operation by the end-effector 130 can be a pre-determined operation (e.g., operate cooling module 131 for a pre-selected time period). However, in other embodiments, the performed operation by the end-effector 130 may be feedback controlled (e.g., operate cooling module 131 until the part or component to be cast reaches a pre-selected temperature as detected by sensing module 137 or operate the cutting module 136 once the part or component to be cast reaches a pre-selected temperature as detected by sensing module 137). After completing an operation with the end-effector 130, the controller 150 can then determine if there are additional operations to be performed in the solidification process (step 310). If there are additional operations to be performed by the end-effector 130, the controller can then move the components of the system 100 into position for the next operation and perform that next operation. The controller 150 can repeat the movement and operation steps until the solidification process is complete. Once the solidification process is complete (i.e., no additional operations are to be performed), the controller 150 can deactivate the system (step 312) and the process can end.

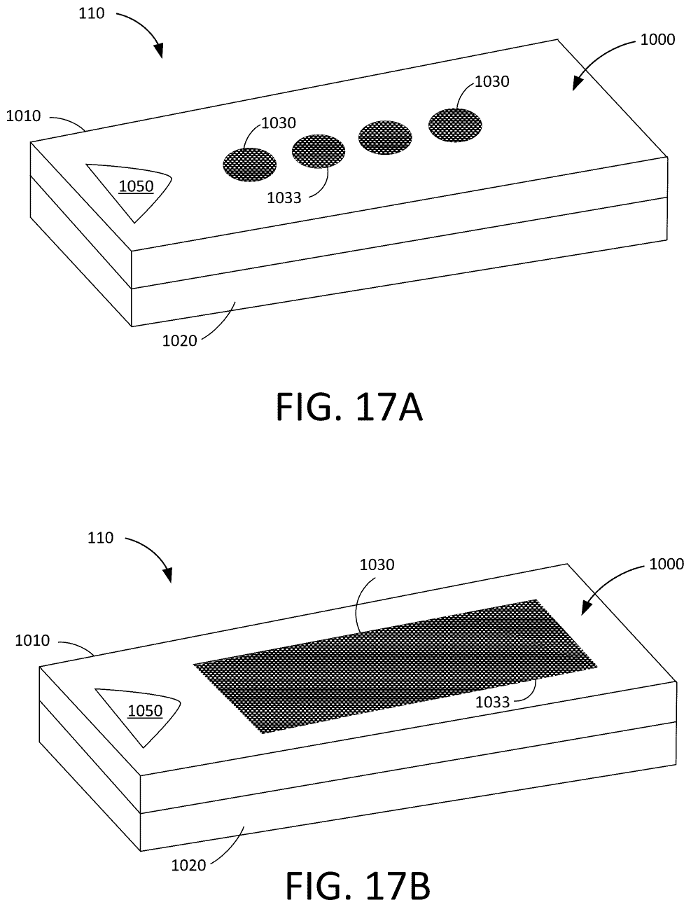

FIGS. 17A and 17B show perspective views of different embodiments of the mold 110 from FIG. 1. The mold 110 can include a mold construction 1000 including one or more inserts 1030. It should be noted that in some embodiments, the mold construction 1000 shown in FIGS. 17A and 17B can have insert(s) 1030 that may be manufactured separately from the mold construction 1000 and subsequently inserted into the mold construction 1000. However, in other embodiments, the mold construction 1000 and the one or more inserts 1030 may be of unitary construction. In other embodiments, the mold construction 1000 and the one or more inserts 1030 may be constructed using additive construction methods, such as a 3D printing manufacturing process. Various materials may be used in the formation of both the one or more inserts 1030 and the mold construction 1000. In some examples, the mold construction 1000 may be formed from an alloy material including metals, ceramics, plastics, etc. In other embodiments, the mold construction 1000 may be partly or wholly constructed of an aggregate material.

The mold construction 1000 can include a cope 1010 and a drag 1020. The cope 1010 can have an outer surface and an opposed inner surface that faces a mold cavity. The drag 1020 similarly includes an outside surface and an opposed inside surface that faces the mold cavity. The mold cavity can be defined as the space between the inside surface of the cope 1010 and the inside surface of the drag 1020 that can receive the molten alloy metal. The mold construction 1000 also includes a sprue 1050 for filling the mold cavity with molten alloy metal for the creation of a desired part or component. In some embodiments, the mold construction 1000 can include a riser for providing a reservoir of molten alloy metal for the mold cavity during the casting process.

The mold cavity can be sized and shaped, as desired, to form differently sized and shaped parts or components. Mold construction 1000 can be fabricated from a variety of materials. In some embodiments, the mold construction 1000 can be constructed of a variety of metal alloys such alloys of iron, nickel, copper, aluminum, magnesium, titanium, etc. In other embodiments, the mold construction 1000 can be constructed of an aggregate material, which can include one or more materials such as silica sand, olivine, chromite, zircon, cenospheres, or mixtures thereof. In yet other embodiments, the mold construction 1000 can be a hybrid of both alloy portions and aggregate portions as desired including plastic, glass, and other materials that have a melting point above the melting point of the alloy metal. It is possible to use materials that have melting points below that of the alloy for the mold because of the ability to provide continuous cooling through the mold construction 1000 with a cooling spray. By providing cooling of the mold construction 1000, it is possible to keep the mold from melting even when the cast part or component has temperatures above the melting point of the mold construction 1000.

As shown in FIG. 17A, the mold construction 1000 includes four substantially circular inserts 1030, while in FIG. 17B, the mold construction 1000 includes a single substantially rectangular insert 1030. However, it should be understood that the number and arrangement of inserts 1030 incorporated within the mold construction 1000 can be varied as desired (e.g., a mold construction 100 can include five substantially rectangular inserts 1030 arranged in parallel). Additionally, the dimensions of the inserts 1030 can be varied as desired depending on the configuration of the component or part being formed within the mold cavity. As shown in FIGS. 17A and 17B, the inserts 1030 are disposed within cope 1010 and can extend from the outside surface of the cope 1010 to the inside surface of the cope 1010 approximate to the mold cavity. Although not shown in FIGS. 17A and 17B, it should be understood that inserts 1030 may also be located within the drag 1020 in a similar manner to the inserts in the cope 110 such that the inserts 1030 can extend from the outside surface of the drag 1020 to the inside surface of the drag 1020 approximate to the mold cavity. In an embodiment, inserts 1030 can be used to support the solidifying molten alloy metal of the part or component during the solidification process, such against hydrostatic pressure and gravity. For example, in embodiments in which the mold construction 1000 is constructed of an aggregate which can be ablated away during the casting process, one or more inserts 1030 can support the cooling alloy metal of the part or component during the solidification process even after the aggregate material is removed from mold construction 1000 via ablation.

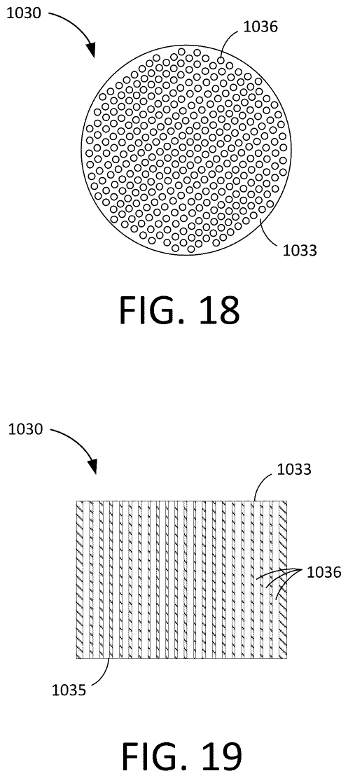

FIG. 18 is an enlarged top view of an embodiment of an insert 1030 from FIG. 17A and FIG. 19 is a cross-section of the insert 1030 from FIG. 18. As shown in FIGS. 18 and 19, an insert 1030 can include a plurality of hollow tubes 1036 extending between the outside surface 1033 of insert 1030 and the opposed inside surface 1035 of insert 1030, thereby connecting or providing passageways between the outside surface of mold construction 1000 and the mold cavity. The use of inserts 1030 with hollow tubes 1036 in a mold construction 1000 can provide for a number of advantages over a traditional mold. For example, it is possible for the progression of molten alloy metal to be visually observed through the plurality of hollow tubes 1036 during the casting process utilizing one or more imaging methods (e.g., via the sensing module 137 of the end-effector 130). Another advantage provided by the plurality of hollow tubes 1036 is the ability to cool the molten metal during the casting process via direct impingement with an ablate material (e.g., via water or another suitable ablate material from cooling modules 131 of the end-effector 130).

The hollow tubes 1036 can also be used to permit the direct heating of portions of the molten alloy metal before, during or after the casting process (e.g., via the energy module 135 of the end-effector 130). For example, infrared radiation or a superheated gas can be introduced through the hollow tubes 1036 to heat certain portions of the part or component to be cast. Further, certain portions of the part or component to be cast can be insulated with or protected by a gas layer by providing an appropriate gas (including, but not limited to carbon dioxide, argon, krypton, nitrogen, cyclopentane, sulfur hexafluoride, sulfur dioxide, propyne, and/or various Freons) through the hollow tubes 1036 into the mold cavity using the cooling modules 131 of the end-effector 130. By introducing an appropriate gas to create a gas layer, cooling of the part or component to be cast can be slowed as well as the heating and expansion of the mold construction 1000 can be prevented.

The insert 1030 can be constructed out of various materials, such as ceramics, metal alloys, carbon and carbon structures or polymers. The plurality of hollow tubes 1036 can be manufactured in various ways. The insert 1030 can be of various shapes and dimensions, but in some embodiments, the insert 1030 can be between approximately 1 mm (millimeter) and approximately 5 mm in diameter. Insert 1030 can include any number of tubes 1036, but in certain embodiments, insert 1030 includes between approximately 400 tubes to 1500 tubes per 25 square millimeter area of the insert 1030. According to some embodiments, the tubes 1036 can have a density within an insert 1030 of approximately 1600 to 6000 tubes per square centimeter. Each tube 1036 can vary in diameter as desired. In some embodiments, the tube diameters can range between approximately 50 microns to approximately 1000 microns. In other embodiments, the length of the tubes 1036 can be approximately 11 mm to 17 mm. Further, the length of the tubes 1036 can vary depending on the particular shape of the cavity (e.g., some tubes 1036 may be longer than other tubes 1036). In an embodiment, the ratio between the diameter of the tubes 1036 and the length of the tubes 1036 within the insert 1030 can be approximately 1:25, although other ratios between the tube diameter and tube length are not precluded. In the embodiment shown in FIG. 18 the tubes 1036 are in a substantially linear orientation, but other configurations of tubes 1036 are possible in other embodiments. Additional information regarding mold constructions with inserts can be found in U.S. Provisional Patent Application No. 63/733,931 entitled “Multi Indirect Injection Solidification Technology,” filed on Dec. 13, 2024 and having an Applicant of Alotech Limited R&D, LLC, which application is incorporated by reference herein in its entirety, and in co-pending U.S. patent application entitled “Multi Indirect Injection Solidification Technology,” filed under Attorney Docket No. 103292.000002USPT on Jan. 16, 2025 and having an Applicant of Alotech Limited R&D, LLC, which application is incorporated by reference herein in its entirety.

The mold construction 1000 of the system 100 can be used to cast parts having desirable properties (e.g., a microstructure having an average cell size of greater than about 5 microns) when used in conjunction with the end-effector 130. The mold construction 1000 can be filled with a molten alloy metal and the solidification process can be started about 1-7 seconds after the mold construction 1000 has been filled. A cooling module 131 of the end-effector 130 can be passed over the mold construction 1000 one or more times during the solidification process. The robotic arm 140 can move the end-effector 130 in a “Z” pattern having both movement in the x-direction and the y-direction relative to the mold construction 1000. Movement in the x-direction is a lateral movement (or side-to-side movement). Movement in the y-direction is an end-to-end movement that travels from the tip of the mold construction 1000 (i.e., the last part of the mold construction 1000 to be filled) to the sprue 1050 or feeder of the mold construction 1000. The robotic arm 140 can move the end-effector 130 at a speed of about 0.4 to about 4.4 meters per second (m/s) in the x-direction and at a speed of about 0.5 to about 12.0 millimeters per second (mm/s) in the y-direction. The cooling module 131 can include a single nozzle that supplies atomized water to the insert 1030, mold construction 1000 and the part to be cast. The atomized water can be provided at a rate of about 0.8 to about 1.2 liters per minute (L/min). The atomized water from the nozzle can be formed from air at a pressure of about 8.0 to about 10.0 bars and water at a pressure of about 5.0 to about 8.0 bars.

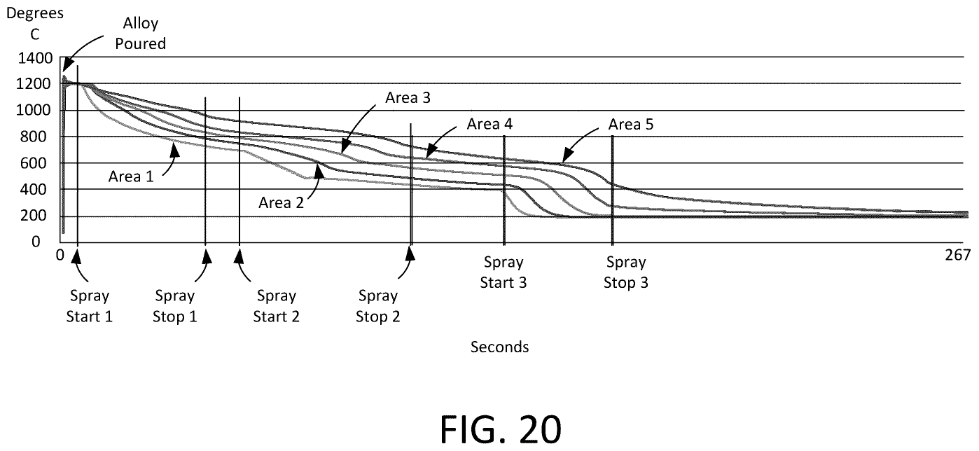

In an embodiment, the mold construction 1000 and the cooling module 131 of the end-effector 100 can be used to cast a part that has a microstructure with a 50 micron or micrometer (μm) average cell size. The mold construction 1000 can be filled with a molten alloy metal such as an aluminum alloy and the solidification process can be started about 3-5 seconds after the mold construction 1000 has been filled. A cooling module 131 of the end-effector 130 can be passed over the mold construction 1000 (starting at the end opposite the sprue 1050) three times during the solidification process. The robotic arm 140 can move the end-effector 130 at a speed of about 20 inches per second (inch/s) in the x-direction and at a speed of about 0.32 inches per second (inch/s) in the y-direction. The cooling module 131 can include a single nozzle that supplies atomized water to the mold construction 1000 and the part to be cast. The atomized water can be provided at a rate of about 0.8 to about 1.2 liters per minute (L/min) at a 60° C. water temperature and the pressure of the air for the atomized water can be 9.0 bar and the pressure for the water for the atomized water can be 7.0 bar. FIG. 20 shows the cooling of the part during the solidification process at five different areas of the mold construction 1000. The temperature measurement of the first area (area 1) can correspond to a location about 2 cm (centimeters) from the end of the cavity opposite the sprue 1050. The temperature measurements for the remaining areas (areas 2-5) can correspond to locations about 3.5 cm from each other with area 2 being next to area 1 and area 5 being closest to the sprue 1050.

The resultant cast part fabricated from the above process can have a microstructure in dark field that showed a fully enriched Mg₂Si within the alpha phase as though heat treated and aged. The structure is unique because in bright field the structure at the cell boundaries did not show homogenization to anticipate the dark field results. In addition, a BHN (Brinell hardness number) of 55 was observed, which is between about 140 Mpa UTS (ultimate tensile strength) and 210 Mpa UTS, with an estimated elongation at 15-20%. The microstructures had, at first examination, a 50 μm average cell size at an end (instead of the expected 20-30 μm average cell size). Further inspection showed the results are consistent through the entire length of the part, i.e., the part had a uniform 50 μm cell size throughout. A fully enriched Mg₂Si alpha post solidification natural age structure absent dissolving grain enriched alloy segregation was observed. In summary, the resultant cast part can have several advantageous features in the microstructure: 1) a uniform 50 μm cell size for the full length of the product; 2) the ripening of Mg₂Si enriched and caught in the alpha structure during solidification; 3) the dispersion uniformity; and 4) the undissolved segregation cell grain boundaries. The resultant cast part shows that alloy alterations to remove grain boundary phases can result in improved elongations with a substantially high material properties.

Although the figures herein may show a specific order of method steps, the order of the steps may differ from what is depicted. Also, two or more steps may be performed concurrently or with partial concurrence. Variations in step performance can depend on the software and hardware systems chosen and on designer choice. All such variations are within the scope of the application. Software implementations could be accomplished with standard programming techniques, with rule based logic and other logic to accomplish the various connection steps, processing steps, comparison steps and decision steps. Machine learning can be further implemented using the processing steps, comparison steps, and decision steps.

It should be understood that the identified embodiments are offered by way of example only. Other substitutions, modifications, changes and omissions may be made in the design, operating conditions and arrangement of the embodiments without departing from the scope of the present application. Accordingly, the present application is not limited to a particular embodiment, but extends to various modifications that nevertheless fall within the scope of the application. It should also be understood that the phraseology and terminology employed herein is for the purpose of description only and should not be regarded as limiting.

What is claimed is:

1. A system for producing a cast alloy metal part, the system comprising:
a robotic system comprising:
a robotic arm; and
an end-effector connected to an end of the robotic arm, the end-effector including at least one module, the at least one module configured to supply an ablate material;
a mold having a cavity configured to receive molten alloy metal, wherein the cavity has a preselected shape corresponding to the part, the mold comprising at least one insert extending from an outer surface of the mold to the cavity, the at least one insert configured to permit the ablate material from the at least one module to travel from the outer surface of the mold to the cavity; and
a control system connected to the robotic system and configured to control operation of the robotic arm and the at least one module such that ablate material is applied to the at least one insert and the mold after the cavity of the mold is filled with molten alloy metal, wherein after application of the ablate material, the cast alloy metal part has an average microstructure of greater than about 5 microns.

2. The system of claim 1, wherein the at least one insert comprises a plurality of tubes extending between the cavity and the outer surface of the mold.

3. The system of claim 2, wherein the plurality of tubes include at least 1600 tubes per square centimeter.

4. The system of claim 2, wherein each tube of the plurality of tubes has a diameter between about 50 microns and about 1000 microns.

5. The system of claim 2, wherein each tube of the plurality of tubes has length between about 11 mm and about 17 mm.

6. The system of claim 1, wherein the at least one module comprises at least one nozzle and the at least one nozzle applies ablate material at a rate between about 0.8 L/min and about 1.2 L/min.

7. The system of claim 6, wherein the ablate material is a cooling fluid and the cooling fluid is at least one of water, air, atomized water, liquid nitrogen or carbonated water.

8. The system of claim 7, wherein the cooling fluid is atomized water and the atomized water is formed from air at a pressure between about 8.0 bars and about 10.0 bars and water at a pressure between about 5.0 bars and about 8.0 bars.

9. The system of claim 1, wherein the control system operates the robotic arm to move the at least one module across a width of the mold at a speed of between about 0.4 m/s and about 4.4 m/s.

10. The system of claim 9, wherein the control system operates the robotic arm to move the at least one module across a length of the mold at a speed of between about 0.5 mm/s and about 12.0 mm/s.

11. A method of producing a cast metal alloy part with a microstructure having an average cell size of greater than 5 microns, the method comprising:
filling a cavity of a mold with a molten metal alloy, wherein the cavity has a preselected shape corresponding to the part, and the mold comprising at least one insert extending from an outer surface of the mold to the cavity;
positioning an end-effector over the mold with a robotic arm, the end-effector including at least one module configured to spray an ablate material;
applying the ablate material to the mold and the at least one insert with the at least one module according to a predefined process; and
solidifying the molten aluminum alloy in the cavity with ablate material travelling through the at least one insert from the outer surface of the mold to the cavity to obtain a cast metal alloy part having an average cell size of greater than 5 microns.

12. The method of claim 11, wherein solidifying the molten aluminum alloy includes solidifying the molten aluminum alloy with ablate material travelling through a plurality of tubes of the at least one insert.

13. The method of claim 12, wherein the plurality of tubes include at least 1600 tubes per square centimeter.

14. The method of claim 12, wherein each tube of the plurality of tubes has a diameter between about 50 microns and about 1000 microns.

15. The method of claim 12, wherein each tube of the plurality of tubes has length between about 11 mm and about 17 mm.

16. The method of claim 11, wherein applying the ablate material to the mold and the at least one insert includes applying ablate material at a rate between about 0.8 L/min and about 1.2 L/min with at least one nozzle.

17. The method of claim 11, wherein applying the ablate material to the mold and the at least one insert includes applying a cooling fluid to the mold and the at least one insert, wherein the cooling fluid is at least one of water, air, atomized water, liquid nitrogen or carbonated water.

18. The method of claim 17, wherein applying the cooling fluid to the mold and the at least one insert includes forming the atomized water from air at a pressure between about 8.0 bars and about 10.0 bars and water at a pressure between about 5.0 bars and about 8.0 bars.

19. The method of claim 11, wherein applying the ablate material to the mold and the at least one insert includes moving the at least one module across a width of the mold at a speed of between about 0.4 m/s and about 4.4 m/s.

20. The method of claim 19, wherein applying the ablate material to the mold and the at least one insert includes moving the at least one module across a length of the mold at a speed of between about 0.5 mm/s and about 12.0 mm/s.
